(19) United States
(12) Patent Application Publication
(10) Pub. No.: US 2010/0310936 A1
(43) Pub. Date: Dec. 9, 2010

(54) CATHODE ACTIVE MATERIAL, CATHODE AND NONAQUEOUS SECONDARY BATTERY

(76) Inventors: Koji Ohira, Osaka (JP); Motoaki Nishijima, Osaka (JP); Isao Tanaka, Kyoto (JP); Yukinori Koyama, Kyoto (JP)

Correspondence Address: NIXON & VANDERHYE, PC, 901 NORTH GLEBE ROAD, 11TH FLOOR, ARLINGTON, VA, 22203, US

(21) Appl. No.: 12/864,790

(22) PCT Filed: Jan. 19, 2009
(86) PCT No.: PCT/JP2009/050687

§ 371 Date: Jul. 27, 2010

(30) Foreign Application Priority Data
Jan. 28, 2008 (JP) 2008-016537

(51) Int. Cl. H01M 4/131; H01M 4/58

(52) U.S. Cl. 429/221; 252/182.1; 252/519.15; 252/519.1

(57) ABSTRACT

The present invention allows production of a battery which not only excels in terms of safety and cost, but also has a long life. A cathode active material of the present invention is represented by the following General Formula (1):

Li_{y}KₐFe₁₋ₓXₓPO₄ (1),

where X is at least one element of groups 2 through 13; 0<a≦0.25; 0≦x≦0.25; and y is (1−a), a volume of a unit lattice for a case in which y in General Formula (1) is (x−a) (when x−a<0, y is 0) having a change ratio of not more than 4% with respect to a volume of a unit lattice for a case in which y in General Formula (1) is (1−a).

### TECHNICAL FIELD

The present invention relates to a cathode active material; a cathode including the cathode active material; and a nonaqueous secondary battery (lithium secondary battery) including the cathode. More particularly, the present invention relates to a nonaqueous secondary battery which has an excellent cycle characteristic.

### BACKGROUND ART

Lithium secondary batteries have been in practical and widespread use as secondary batteries for portable electronic devices. In recent years, as well as compact lithium secondary batteries for use in portable devices, large-capacity lithium secondary batteries have been drawing attention for use, e.g., in cars and as electric energy storages. This has increased a demand in terms of, e.g., safety, cost, and life.

A cathode active material is normally a layered transition metal oxide such as LiCoO₂. Such a layered transition metal oxide is, however, likely to undergo oxygen desorption at a relatively low temperature of approximately 150° C. in a fully charged state. This oxygen desorption may cause a thermal runaway reaction in a battery.

Under the circumstances, highly expected from a safety standpoint is a compound having a stable, spinel structure, such as lithium manganate (LiMn₂O₄) and lithium iron phosphate (LiFePO₄).

From a standpoint of cost, cobalt has a problem that it has a low crustal abundance and is thus expensive. Under the circumstances, highly expected are lithium nickelate (LiNiO₂), its solid solution (Li(Co₁₋ₓNiₓ)O₂), lithium manganate (LiMn₂O₄), and lithium iron phosphate (LiFePO₄).

As a cathode active material such as the above, an active material represented by the following General Formula has been proposed in order to increase a capacity, cycle capability, and reversibility and to reduce a price: AₐM_{b}(XY₄)_{c}Z_{d}, where A is an alkali metal; M is a transition metal; XY₄ is, e.g., PO₄; and Z is, e.g., OH (see, for example, Patent Literature 1).

A detailed arrangement disclosed in Patent Literature 1, however, has a problem that a battery obtained has a short life.

Specifically, according to the arrangement specifically disclosed in Patent Literature 1, the cathode active material greatly expands and shrinks due to charging/discharging. Thus, as the number of cycles increases, the cathode active material physically comes off from a current collector and an electrically conductive material gradually. In other words, in the material which greatly expands and shrinks due to charging/discharging, there occurs a destruction of a secondary particle and/or a conducting path between the cathode active material and the electrically conductive material, thereby increasing an internal resistance of the battery. This increases a portion of the active material which portion does not contribute to charging/discharging. As a result, the capacity is decreased, and the battery thus has a short life.

As described above, an active material which is excellent in terms of all of safety, cost, and life is demanded. However, although lithium iron phosphate, lithium manganate, and the active material whose detailed arrangement is disclosed in Patent Literature 1 are excellent in terms of safety and cost, these active materials have a problem that a ratio of volume expansion/shrinkage due to charging/discharging is high.

### Citation List

Patent Literature 1

Japanese Unexamined Patent Application Publication (Japanese translation of PCT international publication), Tokuhyo, No. 2005-522009 (Publication Date: Jul. 21, 2005)

### SUMMARY OF INVENTION

The present invention has been accomplished in view of the above problem. It is an object of the present invention to produce (i) a cathode active material which allows production of a battery which not only excels in terms of safety and cost, but also has a long life, (ii) a cathode including the cathode active material, and (iii) a nonaqueous secondary battery including the cathode.

In order to solve the above problem, a cathode active material of the present invention is a material represented by the following General Formula (1):

Li_{y}KₐFe₁₋ₓXₓPO₄ (1),

where X is at least one element of groups 2 through 13; 0<a≦0.25; 0≦x≦0.25; and y is (1−a), a volume of a unit lattice for a case in which y in General Formula (1) is (x−a) (when x−a<0, y is 0) having a change ratio of not more than 4% with respect to a volume of a unit lattice for a case in which y in General Formula (1) is (1−a).

According to the above arrangement, the Li site is partially substituted with at least K. This substitution prevents a volume change from occurring due to Li desorption. As a result, in a case where the cathode active material is used to build a battery, it is possible to prevent a cathode from expanding/shrinking due to charging/discharging.

By thus preventing the expansion/shrinkage of the cathode, it is possible to prevent an internal resistance of the battery from increasing due to destruction of a secondary particle and/or a conducting path between the cathode active material and the electrically conductive material, the destruction being caused as the number of charging/discharging cycles increases.

In addition, according to the cathode active material, after the volume change ratio exceeds approximately 4.0%, a ratio of decrease in capacity maintenance ratio with respect to an increase in the volume change ratio becomes large. As such, the above arrangement prevents a decrease in the capacity maintenance ratio.

It follows that according to the above arrangement, it is possible to produce a cathode active material which allows production of a battery which not only excels in terms of safety and cost, but also has a long life.

The cathode active material of the present invention may preferably be arranged such that x in the General Formula (1) is 0<x≦0.25.

According to the above arrangement, a part of the Li site is substituted with K, and simultaneously, a part of the Fe site is substituted with another element. As such, it is also possible to (i) further prevent the expansion/shrinkage caused by charging/discharging and thus (ii) produce a cathode active material which allows production of a battery which has a longer life.

The cathode active material of the present invention may preferably be arranged such that X is a transition element.

The above arrangement makes it possible to carry out charging/discharging with use of a range of a redox potential of X. With the arrangement, in a case where the cathode active material is used to build a battery, it is possible to (i) increase an average electric potential in charging/discharging and (ii) prevent a capacity from decreasing due to the element substitution. As such, it is further possible to produce a cathode active material which allows production of a battery in which a decrease in capacity is further prevented.

In this case, the cathode active material of the present invention may preferably be arranged such that X has a valence of +2.

According to the above arrangement, it is unnecessary to compensate an electric charge. As such, it is further possible to easily synthesize a cathode active material. Specifically, in a case where, for example, X has a valence of +3, it is necessary to lose Li or substitute, with a monovalent element, an amount of the Fe site which amount is equal to that of X.

The cathode active material of the present invention may preferably be arranged such that X is one of Mn, Co, and Ni.

According to the above arrangement, it is possible to produce a cathode active material which allows production of a battery which has a longer life.

Further, the cathode active material of the present invention may preferably be arranged such that X is Mn.

According to the above arrangement, it is possible to produce a cathode active material which allows production of a battery which has a longer life.

Further, the cathode active material of the present invention may preferably be arranged such that a≦x in the General Formula (1).

According to the above arrangement, it is even possible to use an oxidation-reduction reaction of X in order to carry out charging/discharging. As such, it is further possible to produce a cathode active material which allows production of a battery in which a decrease in capacity is further prevented.

The cathode active material of the present invention may preferably be arranged such that X is a typical element.

According to the above arrangement, there occurs no change in valence of X. As such, it is further possible to stably synthesize a cathode active material.

In this case, the cathode active material of the present invention may preferably be arranged such that X has a valence of +2.

According to the above arrangement, it is unnecessary to compensate an electric charge. As such, it is further possible to easily synthesize a cathode active material. In the case where, for example, X has a valence of +3, it is necessary to lose Li and substitute, with a monovalent element, an amount of the Fe site which amount is equal to that of X. Losing Li or substituting Fe with a monovalent element is, however, more difficult than substituting Fe with a bivalent element.

Further, the cathode active material of the present invention may preferably be arranged such that X is Mg.

According to the above arrangement, it is possible to produce a cathode active material which allows production of a battery which has a longer life.

In addition, the cathode active material of the present invention may preferably be arranged such that a=x in the General Formula (1).

The above arrangement can reduce expansion/shrinkage in a cathode active material compared with another cathode active material having the same theoretical capacity as the cathode active material.

Specifically, an increase in the amount of substitution at the Li site causes a linear decrease in theoretical discharge capacity. In contrast, an increase in both substitution amounts at the Li site and the Fe site tends to prevent expansion/shrinkage. Thus, in a case where “a” of the Li site is substituted, the expansion/shrinkage can be most reduced in a cathode active material with a given theoretical capacity when a=x.

In order to solve the above problem, a cathode of the present invention includes: any one of the cathode active materials of the present invention; an electrically conductive material; and a binder.

According to the above arrangement, the cathode includes the cathode active material of the present invention. It follows that according to the above arrangement, it is possible to produce a cathode which allows production of a battery which not only excels in terms of safety and cost, but also has a long life.

In order to solve the above problem, a nonaqueous secondary battery of the present invention includes the cathode of the present invention; an anode; an electrolyte; and a separator.

According to the above arrangement, the nonaqueous secondary battery includes the cathode of the present invention. It follows that according to the above arrangement, it is possible to produce a battery which not only excels in terms of safety and cost, but also has a long life.

### BRIEF DESCRIPTION OF DRAWINGS

FIG. 1 is a graph illustrating a difference in capacity maintenance ratio with respect to volume expansion/shrinkage ratios of respective cathode active materials produced in Examples.

FIG. 2 is a graph illustrating a difference in the volume expansion/shrinkage ratio and initial discharge capacity with respect to respective amounts of substitution with K where X=Mn and x=0.25.

### DESCRIPTION OF EMBODIMENTS

The present invention is described below in detail. Note that in the present specification, a range “from A to B” intends to “not less than A but not more than B”. Properties stated in the present specification are, unless otherwise specified, expressed by values measured in accordance with methods described in Examples below.

(I) Cathode Active Material

A cathode active material of the present embodiment is represented by the following General Formula (1):

Li_{y}KₐFe₁₋ₓXₓPO₄ (1),

where X is at least one element of groups 2 through 13; 0<a≦0.25; 0≦x≦0.25; and y is (1−a).

Generally, lithium iron phosphate having an olivine structure shrinks in volume when Li is desorbed from an initial structure due to charging. In this structural change, an a-axis and a b-axis shrink, whereas a c-axis expands. The inventors of the present invention have thus arrived at an idea that it is possible to reduce the change in volume by reducing a shrinkage ratio of the a-axis and the b-axis and increasing an expansion ratio of the c-axis by means of a substitution.

The inventors have consequently found that by carrying out substitution with respect to a Li site, particularly preferably by simultaneously substituting (i) a part of the Li site with K and (ii) a part of a Fe site with another element, it is possible to prevent the volume change occurring due to the Li desorption and thus prevent the expansion/shrinkage caused by charging/discharging. An initial structure tends to be better maintained during the Li desorption as lattice constants of the initial structure become larger.

Specifically, in a structure observed after the substitution, the a-axis is preferably not less than 10.40 Å, and more preferably not less than 10.45 Å; the b-axis is preferably not less than 6.05 Å, and more preferably not less than 6.10 Å; and the c-axis is preferably not less than 4.70 Å, and more preferably not less than 4.80 Å. Lithium iron phosphate having a general olivine structure has lattice constants of 10.347 Å along the a-axis, 6.0189 Å along the b-axis, and 4.7039 Å along the c-axis.

Note that although most substances having a composition of General Formula (1) have an olivine structure, the scope of the present invention is not limited to an arrangement having an olivine structure. Thus, an arrangement not having an olivine structure is also within the scope of the present invention.

In a case where the Li site is partially substituted with K in a cathode active material, an amount of Li decreases due to the substitution. It follows that in proportion to an amount of the substitution at the Li site, a discharge capacity of a battery including the cathode active material decreases. Thus, as illustrated in FIG. 2, which shows results of the Examples described later, an amount of K partially substituting the Li site is preferably up to ¼ of the Li site. Specifically, according to the cathode active material of the present embodiment, “a” in General Formula (1) is not more than 0.25.

On the other hand, as the amount of K partially substituting the Li site becomes larger, an effect of preventing the volume expansion/shrinkage caused by charging/discharging becomes greater. Thus, according to the cathode active material of the present embodiment, “a” in General Formula (1) is more than 0, and is preferably not less than 0.0625.

An element X partially substituting the Fe site can be a typical metal element or a transition metal element. X is particularly preferably an element having a valence of +2. Specific examples of the element having a valence of +2 encompass Ca, Mg, Ti, V, Cr, Mn, Co, Ni, Cu, and Zn.

In a case where the element X partially substituting the Fe site is a transition metal, charging/discharging can be carried out with use of a range of a redox potential of X. With the arrangement, it is possible to (i) increase an average electric potential in charging/discharging and (ii) prevent a capacity from decreasing due to the element substitution.

X is preferably an element which has an atomic radius in a six-coordinate structure which atomic radius is larger than that of Fe. X is particularly preferably Mn.

Note that in a case where only the Fe site is partially substituted, the Fe site is most effectively substituted with Mn. In the case where the Fe site is partially substituted with Mn at a ratio of x=0.25 in General Formula (1), the volume expansion/shrinkage caused by charging/discharging is 4.26%.

In the present embodiment, a ratio of change in volume of a unit lattice for a case where “y” General Formula (1) is (x−a)(when x−a<0, y is 0) is preferably not more than 4% with respect to a volume of a unit lattice for a case where “y” in General Formula (1) is (1−a).

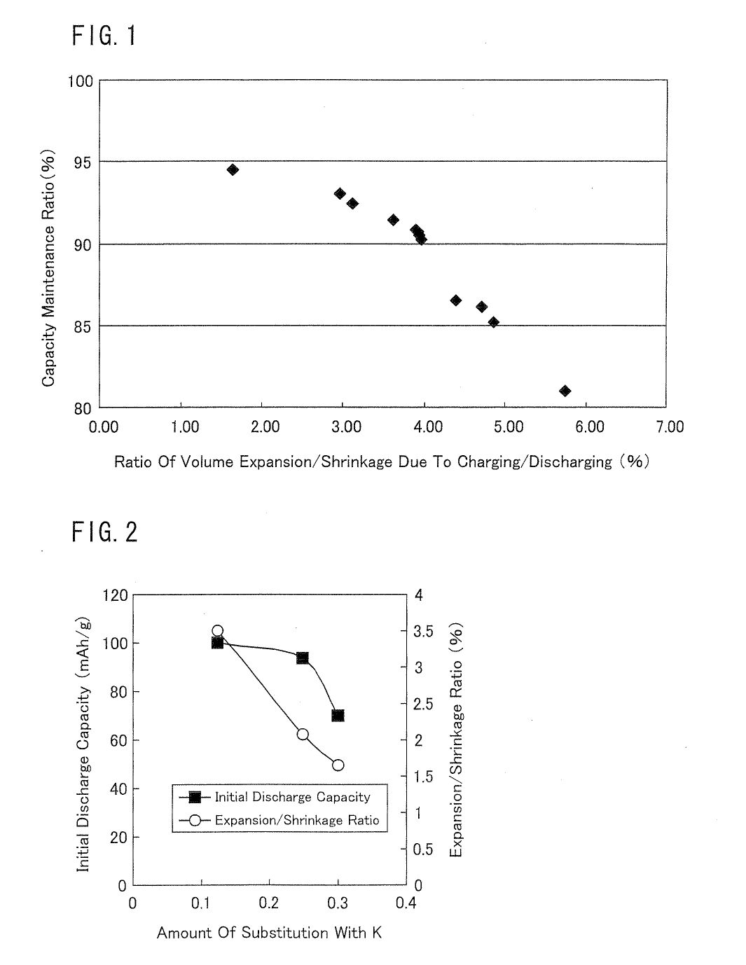

This is due to the following: As illustrated in FIG. 1, which shows results of the Examples described later, according to the cathode active material of the present embodiment, when the ratio of change in volume of the unit lattice reaches approximately 4%, there occurs a change in gradient in a ratio of decrease in capacity maintenance with respect to the ratio of change in volume. In other words, in a case where the ratio of change in volume is higher than approximately 4%, there occurs a larger decrease in the ratio of the capacity maintenance with respect to an increase in the ratio of change in volume. It follows that in the case where the ratio of change in volume is not more than 4%, it is possible to further prevent a decrease in capacity maintenance.

In order for the ratio of change in volume to be not more than 4%, “x” in General Formula (1) is preferably 0<x≦0.25, and is more preferably 0.0625≦x≦0.25. In other words, it is preferable that the Li site and the Fe site are partially substituted simultaneously. With the arrangement, it is possible to (i) minimize a capacity decrease due to the substitution and (ii) prevent the volume expansion/shrinkage due to charging/discharging.

In a case where the Li site and the Fe site are partially substituted simultaneously and X is a typical metal element, an amount of substitution at the Li site is preferably equal to an amount of substitution of the Fe site. If the amount of substitution at the Li site is larger than the amount of substitution of the Fe site, the number of Fe atoms, in which no valence change occurs, will undesirably increase. If the amount of substitution at the Li site is smaller than the amount of substitution at the Fe site, the typical metal element will be undesirably unable to utilize a valence change.

Specifically, an increase in the amount of substitution at the Li site causes a linear decrease in theoretical discharge capacity. In contrast, an increase in both substitution amounts at the Li site and the Fe site tends to prevent expansion/shrinkage. Thus, in a case where an amount “a” of the Li site is substituted, the expansion/shrinkage can be most reduced in a cathode active material with a given theoretical capacity when a=x.

In a case where the Li site and the Fe site are partially substituted simultaneously and X is a transition metal element, the amount of substitution at the Li site is preferably not more than the amount of substitution at the Fe site. In the case where the amount of substitution at the Li site is less than the amount of substitution at the Fe site, it is possible not only to (i) utilize a valence change in atoms with which atoms of the Fe site have been substituted and (ii) prevent the capacity from decreasing due to the atomic substitution, but also to (iii) increase the average electric potential. In this case, X is specifically Ti, V, Cr, Mn, Co, or Ni. In view of an increase in the average electric potential, Mn, Co, and Ni are preferable among the above.

In the case where the Li site and the Fe site are partially substituted simultaneously, it is possible to change structural stability by means of a positional relation between two atoms. As such, by realizing a constant positional relation between such two atoms, it is possible to realize a superlattice structure.

Note that the following has been found: In a case where the Li site partially is substituted with K and the Fe site is partially substituted with Mn, the substitution with K and Mn occurs preferentially at respective portions of the Li site and the Fe site in which portions (i) an octahedron formed by a six-coordinate O centered around K shares no edge with (ii) an octahedron formed by a six-coordinate O centered around Mn.

The cathode active material of the present embodiment described above can be made of, as a material, any combination of, e.g., a carbonate, hydroxide, chloride, sulfate, acetate, oxide, oxalate, or nitrate of each of the above elements. The cathode active material can be produced by a method such as solid phase method, coprecipitation method, hydrothermal method, and spray pyrolysis method. In addition, as in a case of general lithium iron phosphate having an olivine structure, the cathode active material can be provided with a carbon film so as to improve electrical conductivity.

(II) Nonaqueous Secondary Battery

A nonaqueous secondary battery of the present embodiment includes a cathode, an anode, an electrolyte, and a separator. The following description deals with each of the constituent materials.

(a) Cathode

The cathode includes: the cathode active material of the present embodiment; an electrically conductive material; and a binder. The cathode can be made by a publicly known method such as a method in which (i) the active material, the electrically conductive material, and the binder are mixed in an organic solvent so as to prepare a slurry and (ii) the slurry is applied to a current collector.

Examples of the binder encompass: polytetrafluoroethylene; polyvinylidene fluoride; polyvinylchloride; ethylene propylene diene polymer; styrene-butadiene rubber; acrylonitrile butadiene rubber; fluoro rubber; polyvinyl acetate; polymethylmethacrylate; polyethylene; nitrocellulose; etc.

Examples of the electrically conductive material encompass: acetylene black; carbon; graphite; natural graphite; artificial graphite; needle coke; etc.

Examples of the current collector encompass: a foam (porous) metal having contiguous holes; a honeycomb metal; a sintered metal; an expanded metal; nonwoven fabric; a plate; a foil; and a plate or foil having holes; etc.

Examples of the organic solvent encompass: N-methylpyrrolidone; toluene; cyclohexane; dimethylformamide; dimethylacetamide; methylethyl ketone; methyl acetate; methyl acrylate; diethyltriamine; N—N-dimethylaminopropylamine; ethylene oxide; tetrahydrofuran; etc.

The cathode preferably has a thickness which falls within an approximate range from 0.01 to 20 mm. If the thickness is too large, the electrical conductivity will be undesirably low. If the thickness is too small, a capacity per unit area will be undesirably low. In the above case where the cathode is produced by applying and drying the slurry, the cathode may be compacted with use of a roller or the like so as to increase a filling density of the active material.

(b) Anode

The anode can be made by a publicly known method. Specifically, the anode can be made by a method similar to the above-described method for producing the cathode. More specifically, (i) the publicly known binder and publicly known electrically conductive material, both mentioned in the description of the method for producing the cathode, are mixed with an anode active material, (ii) a resulting mixed powder is shaped into a sheet, and (iii) the sheet is pressure-attached to an electrically conductive mesh (current collector) made of, e.g., stainless steel or copper. One alternative method is that the mixed powder is further mixed with the publicly known organic solvent, mentioned in the description of the method for producing the cathode, so as to prepare a slurry, and that the resulting slurry is applied to a metal substrate made of, e.g., copper.

The anode active material can be a publicly known material. In order to produce a battery having a high energy density, it is preferable to employ a material whose electric potential at which Li insertion/desorption occur is close to a electric potential at which precipitation/dissolution of metal lithium occur. Typical examples of the material are carbon materials such as particulate (e.g., scale-like, aggregated, fibrous, whisker-like, spherical, or pulverized-particle-like) natural or artificial graphite.

Examples of the artificial graphite encompass graphite obtained by graphitizing, e.g., mesocarbon microbeads, mesophase pitch powder, or isotropic pitch powder. Alternatively, a graphite particle having a surface on which amorphous carbon is adhered can be used. Among these carbon materials, the natural graphite is more preferable because the natural graphite (i) is inexpensive, (ii) has an electric potential close to a redox potential of lithium, and (iii) makes it possible to produce a battery having a high energy density.

Alternatively, the anode active material can, for example, be lithium transition metal oxide, lithium transition metal nitride, transition metal oxide, or silicon oxide. Among these, Li₄Ti₅O₁₂ is more preferable because it is high in flatness of electric potential and its volume change caused by charging/discharging is small.

(c) Electrolyte

Examples of the electrolyte encompass: an organic electrolyte solution; a gel-like electrolyte; a solid polymer electrolyte; an inorganic solid electrolyte; a molten salt; etc. After the electrolyte is injected into a battery, an opening of the battery is sealed. The battery may be electrified before the sealing so that a gas generated as a result is removed.

Examples of an organic solvent included in the organic electrolyte solution encompass: cyclic carbonates such as propylene carbonate (PC), ethylene carbonate (EC), and butylene carbonate; chain carbonates such as dimethyl carbonate (DMC), diethyl carbonate (DEC), ethyl methyl carbonate, and dipropyl carbonate; lactones such as γ-butyrolactone (GBL) and γ-valerolactone; furans such as tetrahydrofuran and 2-methyltetrahydrofuran; ethers such as diethyl ether, 1,2-dimethoxy ethane, 1,2-diethoxy ethane, ethoxy methoxy ethane, and dioxane; dimethyl sulfoxide; sulfolane; methylsulfolane; acetonitrile; methyl formate; methyl acetate; etc. More than one of the above organic solvents may also be mixed for use.

Among the above organic solvents, GBL not only has both a high dielectric constant and a low viscosity, but also has such advantages as a high oxidation resistance, a high boiling point, a low vapor pressure, and a high flash point. As such, GBL is particularly suitable as a solvent for an electrolyte solution of a large lithium secondary battery, for which safety is much required as compared to a conventional compact lithium secondary battery.

Each of the cyclic carbonates such as PC, EC, and butylene carbonate is a solvent having a high boiling point, and is thus a solvent suitable to be mixed with GBL.

Examples of an electrolyte salt included in the organic electrolyte solution encompass: lithium salts such as lithium borofluoride (LiBF₄), lithium hexafluorophosphate (LiPF₆), lithium trifluoromethanesulfonate (LiCF₃SO₃), lithium trifluoroacetate (LiCF₃COO), and lithium-bis(trifluoromethanesulfonate)imide (LiN(CF₃SO₂)₂). More than one of the above electrolyte salts may also be used in combination. The electrolyte solution preferably has a salt concentration which falls within a range from 0.5 to 3 mol/l.

(d) Separator

Examples of the separator encompass a porous material, unwoven fabric, etc. The separator is preferably made of a material which neither dissolves nor swells in the above organic solvent included in the electrolyte. Specific examples of the material encompass a polyester polymer, polyolefin polymer (e.g., polyethylene and polypropylene), ether polymer, an inorganic material such as glass, etc.

Note that according to the battery of the present embodiment, components such as structural materials including, e.g., the separator and a battery casing are also not particularly limited. Thus, various materials used in conventionally known nonaqueous electrolyte secondary batteries can be used.

(e) Method for Producing Nonaqueous Secondary Battery

The nonaqueous secondary battery of the present embodiment can be produced by, e.g., laminating the cathode and the anode with the separator sandwiched between them. The lamination of the electrodes can, for example, have a planar strip shape. In a case where a cylindrical or flat battery is produced, the lamination of the electrodes can be rolled up.

Either a single lamination of the electrodes or a plurality of such laminations are inserted into a battery casing. The cathode and the anode are then normally connected to respective external conductive terminals of the battery. After that, the battery casing is hermetically sealed so that none of the electrodes and the separator is in contact with external air.

In the case where a cylindrical battery is produced, the sealing is normally carried out by caulking an opening of the battery casing with a lid having a resin packing. In a case where a square battery is produced, a metal lid called a sealing plate is attached and welded to the opening. Other than these methods, the battery casing can be hermetically sealed (i) with use of a binder or (ii) by bolting a lid via a gasket. Further, the battery casing can also be hermetically sealed with use of a laminate film in which a thermoplastic resin is attached to a metal foil. An opening for injecting the electrolyte may be formed when the sealing is carried out.

As described above, the cathode active material of the present invention is represented by the following General Formula (I):

Li_{y}KₐFe₁₋ₓXₓPO₄ (1),

where X is at least one element of groups 2 through 13; 0<a≦0.25; 0≦x≦0.25; and y is (1−a), a volume of a unit lattice for a case in which y in General Formula (1) is (x−a) (when x−a<0, y is 0) having a change ratio of not more than 4% with respect to a volume of a unit lattice for a case in which y in General Formula (1) is (1−a).

The present invention with this configuration makes it possible to produce a cathode active material which allows production of a battery which not only excels in terms of safety and cost, but also has a long life.

As described above, the cathode of the present invention includes: a cathode active material of the present invention; an electrically conductive material; and a binder.

The present invention with this configuration makes it possible to produce a cathode which allows production of a battery which not only excels in terms of safety and cost, but also has a long life.

As described above, the nonaqueous secondary battery of the present invention includes: the cathode of the present invention; an anode; an electrolyte; and a separator.

The present invention with this configuration makes it possible to produce a battery which not only excels in terms of safety and cost, but also has a long life.

Note that the present invention described above may alternatively be stated as follows:

(1) A nonaqueous secondary battery including: a cathode; an anode; an electrolyte; and a separator, the cathode including: a cathode active material; an electrically conductive material; and a binder, the cathode active material being represented by Li_{1-a-b}KₐFe₁₋ₓXₓPO₄ (where 0<a≦0.25; and 0≦x≦0.25), X being at least one element of groups 2 through 12, the cathode active material being arranged such that a volume of a unit lattice for a case in which b=1−x (when x<a, b=1−a) having a ratio of volume change due to charging/discharging which ratio is not more than 4% with respect to a volume of a unit lattice for a case in which b=0.

(2) The battery wherein X is a typical element in the electrode active material described in (1).

(3) The battery wherein X has a valence of +2 in the electrode active material described in (2).

(4) The battery wherein X is Mg in the electrode active material described in (3).

(5) The battery wherein a=x in the electrode active material described in (4).

(6) The battery wherein X is a transition element in the electrode active material described in (1).

(7) The battery wherein X has a valence of +2 in the electrode active material described in (6).

(8) The battery wherein X is Mn, Co, or Ni in the electrode active material described in (7).

(9) The battery wherein X is Mn in the electrode active material described in (8).

(10) The battery wherein in the electrode active material described in (9).

### EXAMPLES

The following description deals in further detail with the present invention with reference to Examples. The present invention is, however, not limited to the Examples below. Note that reagents and the like used in the Examples were special grade reagents available from Kishida Chemical Co., Ltd., unless otherwise specified.

A cathode active material obtained in each of the Examples and Comparative Examples was subjected to ICP emission spectrochemical analysis so as to confirm that the cathode active material had its target composition (element ratio).

<Expansion/Shrinkage Ratio of Cathode Active Material>

Each cathode active material was ground in a mortar into a fine powder. An X-ray measurement was then carried out with respect to the fine powder at room temperature within a range from 10° to 90° with use of a Cu tube so as to find lattice constants.

In order to find lattice constants of a post-Li desorption active material, an X-ray measurement was carried out at room temperature with respect to, as a post-Li desorption cathode active material, a cathode active material having a composition identical to that of a cathode active material whose Li desorption had been confirmed on the basis of a charging capacity. Specifically, the following steps were sequentially carried out: (i) a battery was produced by a method described later for producing a battery, (ii) the battery was fully charged, (iii) a cathode was taken out from the battery, (iv) the cathode was washed with ethanol, and (v) an XRD measurement was carried out with respect to the post-Li desorption cathode active material.

A ratio (%) of volume expansion/shrinkage due to charging/discharging was found by (i) finding a volume of a charged structure on the basis of its lattice constants, finding a volume of a discharged structure on the basis of its lattice constants, and (iii) calculating the following equation:

Volume expansion ratio (%)=(1−volume of charged structure/volume of discharged structure)×100.

Note that the charged structure intends to a structure from which Li had been desorbed and the discharged structure intends to an initial structure as originally synthesized.

<Method for Producing Battery>

A cathode active material, acetylene black (product name: “Denka Black”; manufactured by Denki Kagaku Kogyo Kabushiki Kaisha), and PVdF (polyvinylidene fluoride; product name: “KF polymer”; manufactured by Kureha Corporation) were mixed at a ratio of 100:5:5. A resulting mixture was then mixed with N-methylpyrrolidone (manufactured by Kishida Chemical Co., Ltd.) so as to provide a slurry mixture. This slurry mixture was applied to an aluminum foil having a thickness of 20 μm so that the slurry mixture had a thickness ranging from 50 μm to 100 μm. As a result, a cathode was produced. Note that cathode electrodes each had a size of 2 cm×2 cm.

Next, the cathode was dried. An cathode electrode and Li metal serving as a counter electrode were then soaked in 50 ml of an electrolyte solution contained in a 100 ml glass container. The electrolyte solution (manufactured by Kishida Chemical Co., Ltd.) was prepared by dissolving LiPF₆ at a concentration of 1.4 mol/l in a solvent in which ethylene carbonate and diethyl carbonate were mixed at a volume ratio of 7:3.

<Capacity Maintenance Ratio>

In order to find a capacity maintenance ratio, a cyclic test was carried out in which the battery as produced above was charged and discharged at a current density of 0.2 mA/cm². The charging was carried out in such a manner that (i) a constant current charging mode was switched to a constant voltage charging mode at a voltage of 3.8 V, and (ii) when a current value reached 1/10 of a current value achieved in the constant current charging mode, the charging was ended. The discharging was carried out at a constant current until a voltage reached 2.25 V. The capacity maintenance ratio was found, on the basis of a capacity obtained after 300 cycles, from the following equation:

Capacity maintenance ratio (%)=(discharge capacity observed after 300 cycles)/(initial discharge capacity).

### Example 1

As starting materials, LiOH serving as a lithium source; KOH serving as a potassium source; FePO₄ serving as an iron source; MnO serving as a manganese source; and (NH₄)₂HPO₄ serving as a phosphate source were mixed at a ratio of Li:K:Fe:Mn:P=0.75:0.25:0.75:0.25:1. A resulting mixture was then calcinated in a nitrogen atmosphere at 650° C. for 6 hours. This synthesized single-phase powder of Li_{0.75}K_{0.25}Fe_{0.75}Mn_{0.25}PO₄, which was a cathode active material having an olivine structure. Table 1 shows results of respective measurements.

### Example 2

As starting materials, LiOH serving as a lithium source; KOH serving as a potassium source; FePO₄ serving as an iron source; MnO serving as a manganese source; and (NH₄)₂HPO₄ serving as a phosphate source were mixed at a ratio of Li:K:Fe:Mn:P=0.875:0.125:0.75:0.25:1. A resulting mixture was then calcinated in a nitrogen atmosphere at 650° C. for 6 hours. This synthesized single-phase powder of Li_{0.875}K_{0.125}Fe_{0.75}Mn_{0.25}PO₄, which was a cathode active material having an olivine structure. Table 1 shows results of respective measurements.

### Example 3

As starting materials, LiOH serving as a lithium source; KOH serving as a potassium source; FePO₄ serving as an iron source; MnO serving as a manganese source; and (NH₄)₂HPO₄ serving as a phosphate source were mixed at a ratio of Li:K:Fe:Mn:P=0.875:0.125:0.875:0.125:1. A resulting mixture was then calcinated in a nitrogen atmosphere at 650° C. for 6 hours. This synthesized single-phase powder of Li_{0.875}K_{0.125}Fe_{0.875}Mn_{0.125}PO₄, which was a cathode active material having an olivine structure. Table 1 shows results of respective measurements.

### Example 4

As starting materials, LiOH serving as a lithium source; KOH serving as a potassium source; FePO₄ serving as an iron source; MgO serving as a magnesium source; and (NH₄)₂HPO₄ serving as a phosphate source were mixed at a ratio of Li:K:Fe:Mg:P=0.75:0.25:0.75:0.25:1. A resulting mixture was then calcinated in a nitrogen atmosphere at 650° C. for 6 hours. This synthesized single-phase powder of Li_{0.75}K_{0.25}Fe_{0.75}Mn_{0.25}PO₄, which was a cathode active material having an olivine structure. Table 1 shows results of respective measurements.

### Example 5

As starting materials, LiOH serving as a lithium source; KOH serving as a potassium source; FePO₄ serving as an iron source; NiO serving as a nickel source; and (NH₄)₂HPO₄ serving as a phosphate source were mixed at a ratio of Li:K:Fe:Ni:P=0.75:0.25:0.75:0.25:1. A resulting mixture was then calcinated in a nitrogen atmosphere at 650° C. for 6 hours. This synthesized single-phase powder of Li_{0.75}K_{0.25}Fe_{0.75}Mn_{0.25}PO₄, which was a cathode active material having an olivine structure. Table 1 shows results of respective measurements.

### Example 6

As starting materials, LiOH serving as a lithium source; KOH serving as a potassium source; FePO₄ serving as an iron source; CO₃O₄ serving as a cobalt source; and (NH₄)₂HPO₄ serving as a phosphate source were mixed at a ratio of Li:K:Fe:Co:P=0.75:0.25:0.75:0.25:1. A resulting mixture was then calcinated in a nitrogen atmosphere at 650° C. for 6 hours. This synthesized single-phase powder of Li_{0.75}K_{0.25}Fe_{0.75}Mn_{0.25}PO₄, which was a cathode active material having an olivine structure. Table 1 shows results of respective measurements.

### Example 7

As starting materials, LiOH serving as a lithium source; KOH serving as a potassium source; FePO₄ serving as an iron source; CuO serving as a copper source; and (NH₄)₂HPO₄ serving as a phosphate source were mixed at a ratio of Li:K:Fe:Cu:P=0.75:0.25:0.75:0.25:1. A resulting mixture was then calcinated in a nitrogen atmosphere at 650° C. for 6 hours. This synthesized single-phase powder of Li_{0.75}K_{0.25}Fe_{0.75}Mn_{0.25}PO₄, which was a cathode active material having an olivine structure. Table 1 shows results of respective measurements.

### Example 8

As starting materials, LiOH serving as a lithium source; KOH serving as a potassium source; FePO₄ serving as an iron source; MnO serving as a manganese source; NiO serving as a nickel source; and (NH₄)₂HPO₄ serving as a phosphate source were mixed at a ratio of Li:K:Fe:Mn:Ni:P=0.75:0.25:0.75:0.125:0.125:1. A resulting mixture was then calcinated in a nitrogen atmosphere at 650° C. for 6 hours. This synthesized single-phase powder of Li_{0.75}K_{0.25}Fe_{0.75}Mn_{0.125}Ni_{0.125}PO₄, which was a cathode active material having an olivine structure. Table 1 shows results of respective measurements.

### Example 9

As starting materials, LiOH serving as a lithium source; KOH serving as a potassium source; FePO₄ serving as an iron source; and (NH₄)₂HPO₄ serving as a phosphate source were mixed at a ratio of Li:K:Fe:P=0.75:0.25:1:1. A resulting mixture was then calcinated in a nitrogen atmosphere at 650° C. for 6 hours. This synthesized single-phase powder of Li_{0.75}K_{0.25}FePO₄, which was a cathode active material having an olivine structure. Table 1 shows results of respective measurements.

### Comparative Example 1

As starting materials, LiOH serving as a lithium source; KOH serving as a potassium source; FePO₄ serving as an iron source; MgO serving as a magnesium source; and (NH₄)₂HPO₄ serving as a phosphate source were mixed at a ratio of Li:K:Fe:Mg:P=0.875:0.125:0.75:0.25:1. A resulting mixture was then calcinated in a nitrogen atmosphere at 650° C. for 6 hours. This synthesized single-phase powder of Li_{0.875}K_{0.125}Fe_{0.75}Mn_{0.25}PO₄, which was a cathode active material having an olivine structure. Table 1 shows results of respective measurements.

### Comparative Example 2

As starting materials, LiOH serving as a lithium source; NaOH serving as a sodium source; FePO₄ serving as an iron source; MnO serving as a manganese source; and (NH₄)₂HPO₄ serving as a phosphate source were mixed at a ratio of Li:Na:Fe:Mn:P=0.75:0.25:0.75:0.25:1. A resulting mixture was then calcinated in a nitrogen atmosphere at 650° C. for 6 hours. This synthesized single-phase powder of Li_{0.75}K_{0.25}Fe_{0.75}Mn_{0.25}PO₄, which was a cathode active material having an olivine structure. Table 1 shows results of respective measurements.

### Comparative Example 3

As starting materials, LiOH serving as a lithium source; KOH serving as a potassium source; FePO₄ serving as an iron source; MnO serving as a manganese source; and (NH₄)₂HPO₄ serving as a phosphate source were mixed at a ratio of Li:K:Fe:Mn:P=0.7:0.3:0.7:0.3:1. A resulting mixture was then calcinated in a nitrogen atmosphere at 650° C. for 6 hours. This synthesized single-phase powder of Li_{0.7}K_{0.3}Fe_{0.7}Mn_{0.3}PO₄, which was a cathode active material having an olivine structure. Table 1 shows results of respective measurements.

### Comparative Example 4

As starting materials, LiOH serving as a lithium source; NaOH serving as a sodium source; FePO₄ serving as an iron source; MgO serving as a manganese source; and (NH₄)₂HPO₄ serving as a phosphate source were mixed at a ratio of Li:Na:Fe:Mg:P=0.75:0.25:0.75:0.25:1. A resulting mixture was then calcinated in a nitrogen atmosphere at 650° C. for 6 hours. This synthesized single-phase powder of Li_{0.75}Na_{0.25}Fe_{0.75}Mn_{0.25}PO₄, which was a cathode active material having an olivine structure. Table 1 shows results of respective measurements.

### Comparative Example 5

As starting materials, LiOH serving as a lithium source; NaOH serving as a sodium source; FePO₄ serving as an iron source; NiO serving as a manganese source; and (NH₄)₂HPO₄ serving as a phosphate source were mixed at a ratio of Li:Na:Fe:Ni:P=0.75:0.25:0.75:0.25:1. A resulting mixture was then calcinated in a nitrogen atmosphere at 650° C. for 6 hours. This synthesized single-phase powder of Li_{0.75}K_{0.25}Fe_{0.75}Mn_{0.25}PO₄, which was a cathode active material having an olivine structure. Table 1 shows results of respective measurements.

TABLE 1

| | | | | | Expansion/ | Capacity | Initial |
|---|---|---|---|---|---|---|---|
| | | a-axis | b-axis | c-axis | shrinkage | maintenance | discharge capacity |
| | Composition*¹ | (Å) | (Å) | (Å) | ratio (%) | ratio (%) | (mAh/g) |
| Example 1 | Li_{0.75}K_{0.25}Fe_{0.75}Mn_{0.25}PO₄ | 10.488 | 6.153 | 4.806 | 2.07 | 94.2 | 93.8 |
| | K_{0.25}Fe_{0.75}Mn_{0.25}PO₄ | 10.218 | 5.975 | 4.975 | | | |
| Example 2 | Li_{0.875}K_{0.125}Fe_{0.75}Mn_{0.25}PO₄ | 10.463 | 6.09 | 4.761 | 3.5 | 92.0 | 100 |
| | K_{0.125}Fe_{0.75}Mn_{0.25}PO₄ | 10.202 | 5.88 | 4.88 | | | |
| Example 3 | Li_{0.875}K_{0.125}Fe_{0.875}Mn_{0.125}PO₄ | 10.418 | 6.087 | 4.756 | 3.93 | 90.5 | 109.4 |
| | K_{0.125}Fe_{0.875}Mn_{0.125}PO₄ | 10.118 | 5.873 | 4.876 | | | |
| Example 4 | Li_{0.75}K_{0.25}Fe_{0.75}Mg_{0.25}PO₄ | 10.47 | 6.135 | 4.825 | 3.92 | 90.7 | 91.3 |
| | K_{0.25}Fe_{0.75}Mg_{0.25}PO₄ | 10.143 | 5.934 | 4.947 | | | |
| Example 5 | Li_{0.75}K_{0.25}Fe_{0.75}Ni_{0.25}PO₄ | 10.429 | 6.126 | 4.814 | 3.89 | 90.8 | 92.5 |
| | K_{0.25}Fe_{0.75}Ni_{0.25}PO₄ | 10.111 | 5.911 | 4.946 | | | |
| Example 6 | Li_{0.75}K_{0.25}Fe_{0.75}Co_{0.25}PO₄ | 10.488 | 6.143 | 4.825 | 3.96 | 90.2 | 92.3 |
| | K_{0.25}Fe_{0.75}Co_{0.25}PO₄ | 10.139 | 5.941 | 4.957 | | | |
| Example 7 | Li_{0.75}K_{0.25}Fe_{0.75}Cu_{0.25}PO₄ | 10.507 | 6.067 | 4.821 | 3.12 | 92.4 | 91.6 |
| | K_{0.25}Fe_{0.75}Cu_{0.25}PO₄ | 10.069 | 5.953 | 4.967 | | | |
| Example 8 | Li_{0.75}K_{0.25}Fe_{0.75}Mn_{0.125}Ni_{0.125}PO₄ | 10.458 | 6.14 | 4.81 | 2.98 | 93.0 | 91.1 |
| | K_{0.25}Fe_{0.75}Mn_{0.125}Ni_{0.125}PO₄ | 10.164 | 5.943 | 4.961 | | | |
| Example 9 | Li_{0.75}K_{0.25}FePO₄ | 10.451 | 6.151 | 4.814 | 3.62 | 91.4 | 92.8 |
| | K_{0.25}FePO₄ | 10.133 | 5.96 | 4.939 | | | |
| Comparative Example 1 | Li_{0.875}K_{0.125}Fe_{0.75}Mg_{0.25}PO₄ | 10.4 | 6.069 | 4.774 | 5.74 | 81.0 | 99.4 |
| | Li_{0.125}K_{0.125}Fe_{0.75}Mg_{0.25}PO₄ | 10.044 | 5.833 | 4.848 | | | |
| Comparative Example 2 | Li_{0.75}Na_{0.25}Fe_{0.75}Mn_{0.25}PO₄ | 10.416 | 5.873 | 4.761 | 4.39 | 86.5 | 96.3 |
| | Na_{0.25}Fe_{0.75}Mn_{0.25}PO₄ | 10.114 | 5.887 | 4.849 | | | |
| Comparative Example 3 | Li_{0.7}K_{0.3}Fe_{0.7}Mn_{0.3}PO₄ | 10.378 | 6.158 | 4.784 | 1.65 | 94.5 | 70 |
| | K_{0.3}Fe_{0.7}Mn_{0.3}PO₄ | 10.118 | 5.954 | 4.992 | | | |
| Comparative Example 4 | Li_{0.75}Na_{0.25}Fe_{0.75}Mg_{0.25}PO₄ | 10.337 | 6.042 | 4.752 | 4.72 | 86.1 | 91.5 |
| | Na_{0.25}Fe_{0.75}Mg_{0.25}PO₄ | 10.048 | 5.835 | 4.823 | | | |
| Comparative Example 5 | Li_{0.75}Na_{0.25}Fe_{0.75}Ni_{0.25}PO₄ | 10.308 | 6.035 | 4.749 | 4.86 | 85.2 | 92.8 |
| | Na_{0.25}Fe_{0.75}Ni_{0.25}PO₄ | 10.027 | 5.822 | 4.815 | | | |

*¹Discharged structure (above) and charged structure (below)

FIG. 1 is a graph showing a difference in the capacity maintenance ratio with respect to volume expansion/shrinkage ratios of the respective cathode active materials produced in the Examples.

As illustrated in FIG. 1, after the volume expansion/shrinkage ratio exceeds approximately 4%, the capacity maintenance ratio decreases rapidly. This demonstrates that the cathode active material of the present embodiment preferably has a volume expansion/shrinkage ratio of not more than approximately 4%.

As shown in Table 1, according to Examples 1 to 3, in which X=Mn, a decrease in the initial discharge capacity with respect to a decrease in the volume expansion/shrinkage ratio is reduced as compared to Comparative Example 3, in which although X=Mn, a=0.3.

FIG. 2 is a graph illustrating a difference in the volume expansion/shrinkage ratio and initial discharge capacity with respect to a change in “a” where X=Mn.

As illustrated in FIG. 2, the volume expansion/shrinkage ratio linearly changes with respect to an amount “a” of substitution with K, whereas the initial discharge capacity decreases rapidly after the amount “a” of substitution with K exceeds 0.25. This demonstrates that “a” in General Formula (1) is preferably not more than 0.25.

As compared to the cathode active material of Example 1, the cathode active material of Comparative Example 2, in which K in the cathode active material of Example 1 was replaced by Na, demonstrates that it has a low ratio of decrease in the expansion/shrinkage ratio with respect to a decrease in the initial discharge capacity. The cathode active material of Example 1 thus excelled the cathode active material of Comparative Example 2.

According to Examples 4 to 9, in which X≠Mn, the capacity maintenance ratio and the initial discharge capacity were excellent as well as in Examples 1 to 3.

The present invention is not limited to the description of the embodiments above, but may be altered in various ways by a skilled person within the scope of the claims. Any embodiment based on a proper combination of technical means disclosed in different embodiments is also encompassed in the technical scope of the present invention.

### INDUSTRIAL APPLICABILITY

The cathode active material of the present invention allows production of a battery which not only excels in terms of safety and cost, but also has a long life. The cathode active material is thus suitably applicable as a cathode active material for use in a nonaqueous secondary battery such as a lithium ion battery.

1. A cathode active material represented by the following General Formula (1):
Li_{y}KₐFe₁₋ₓXₓPO₄ (1),
where X is at least one element of groups 2 through 13; 0<a≦0.25; 0≦x≦0.25; and y is (1−a),
a volume of a unit lattice for a case in which y in General Formula (1) is (x−a) (when x−a<0, y is 0) having a change ratio of not more than 4% with respect to a volume of a unit lattice for a case in which y in General Formula (1) is (1−a).

2. The cathode active material according to claim 1, wherein x in the General Formula (1) is 0<x≦0.25.

3. The cathode active material according to claim 1, wherein X is a transition element.

4. The cathode active material according to claim 3, wherein X has a valence of +2.

5. The cathode active material according to claim 4, wherein X is one of Mn, Co, and Ni.

6. The cathode active material according to claim 5, wherein X is Mn.

7. The cathode active material according to claim 3, wherein a≦x in the General Formula (1).

8. The according to claim 1, wherein X is a typical element.

9. The cathode active material according to claim 8, wherein X has a valence of +2.

10. The cathode active material according to claim 9, wherein X is Mg.

11. The cathode active material according to claim 8, wherein a=x in the General Formula (1).

12. A cathode comprising:
a cathode active material recited in claim 1;
an electrically conductive-material; and
a binder.

13. A nonaqueous secondary battery comprising:
the cathode recited in claim 12;
an anode;
an electrolyte; and
a separator.
